(19) United States
(12) Patent Application Publication
(10) Pub. No.: US 2013/0067763 A1
(43) Pub. Date: Mar. 21, 2013

(54) METHOD OF CONTROLLING THE FINISHING OF OPERATION OF A DRYING FURNACE ASSEMBLY IN A FOOD WASTE DISPOSER

(71) Applicants: Sang Jun Jee, Seoul (KR); Chan Jung Park, Seoul (KR); Tae Seok Shin, Seoul (KR)

(72) Inventors: Sang Jun Jee, Seoul (KR); Chan Jung Park, Seoul (KR); Tae Seok Shin, Seoul (KR)

(73) Assignee: WOONGJIN COWAY CO., LTD., Gongju-si (KR)

(21) Appl. No.: 13/643,049

(22) PCT Filed: May 12, 2011
(86) PCT No.: PCT/KR2011/003487

§ 371 Date: Dec. 4, 2012

(30) Foreign Application Priority Data
May 12, 2010 (KR) 10-2010-0044648
May 4, 2011 (KR) 10-2011-0042675

(51) Int. Cl. F26B 3/02

(52) U.S. Cl. CPC F26B 3/02
USPC 34/514

(57) ABSTRACT

A method of finishing the operation of a heating unit based either on a temperature difference between a drying furnace temperature and a recycling gas duct temperature or on a temperature difference between an exhaust gas duct temperature and a recycling gas duct temperature instead of finishing the operation of the heating unit based only on the drying furnace temperature.

### TECHNICAL FIELD

The present invention relates to a method of controlling the finishing of operation of a drying furnace assembly in a food waste disposer.

### BACKGROUND ART

Food wastes are generated every day at home, in restaurants, etc. and most of them have been typically discarded after straining them to remove water. However, this method increases the amount of wastes and causes the wastes to smell bad, thereby contaminating atmospheric air. Therefore, at home and restaurants these days, reduction of the amount of food wastes is being actively pursued, and, in as part of these efforts, food waste disposers have been widely used.

Water forms a large percentage of food wastes, so that a conventional heating and drying type food waste disposer treats the food wastes in a drying furnace through a crushing/agitating/drying process, thereby reducing the volume of wastes. In this process, the food waste disposer generates high temperature exhaust gas.

The high temperature exhaust gas is cooled by a cooling unit, such as a heat exchanger, and becomes condensed water, which is collected in a buffer tank. The condensed water collected in the buffer tank may be discarded to the outside of the buffer tank by a user or may be recycled into the drying furnace in a state of recycling gas.

When the heating unit used for heating the drying furnace is stopped too late, the temperature of the drying furnace excessively increases, thereby increasing the time required to finish the food waste disposal and places users in danger. However, when the heating unit is stopped too soon, the food wastes in the drying furnace are discharged in an insufficiently dried state, thereby failing to realize the desired effects of food waste disposal.

In an effort to solve the problems, in the related art, a technique has been used in which the finishing of operation of the heating unit is controlled based on a detected temperature of the drying furnace.

However, in a food waste disposer in which exhaust gas recycles into the drying furnace without being entirely discharged to the outside, the technique in which the finishing of the operation of the heating unit is controlled based on the drying furnace temperature may cause problems of insufficient food waste disposal effects or of an excessive increase in the drying furnace temperature due to the cooled recycling gas which recycles into the drying furnace.

### DISCLOSURE OF INVENTION

### Technical Problem

Accordingly, the present invention has been made keeping in mind the above problems occurring in the related art, and is intended to provide a method that can solve the problems occurring in the conventional method of controlling the finishing of operation of a heating unit based only on a drying furnace temperature in a recycling type food waste disposer.

### Solution to Problem

In an aspect, the present invention provides a method of controlling the finishing of operation of a heating unit based either on a temperature difference between inlet and outlet ends of a heat exchanger or on a temperature difference between a drying furnace and the outlet end of the heat exchanger instead of controlling the finishing of operation of the heating unit based only on the temperature of the drying furnace. In an embodiment, the temperature of the inlet end of the heat exchanger can be determined from a temperature of an exhaust gas duct and the temperature of the outlet end of the heat exchanger can be determined from a temperature of the recycling gas duct.

Described in detail, according to a first embodiment of the present invention, there is provided a method of controlling the finishing of operation of a drying furnace assembly, the assembly including: a drying furnace heated by a heating unit; and a heat exchanger receiving exhaust gas generated in the drying furnace through an inlet end of the heat exchanger and causing the inlet exhaust gas to exchange heat therein and to become recycling gas, and discharging the recycling gas through an outlet end thereof, wherein the recycling gas recycles into the drying furnace, the method including: (a) operating the drying furnace; (b) detecting a temperature T₂ of the drying furnace; (c) detecting a temperature T₃ of the outlet end of the heat exchanger; and (d) finishing the operation of the heating unit when a temperature difference ΔT between the temperature T₂ of the drying furnace and the temperature T₃ of the outlet end of the heat exchanger is not less than a predetermined first temperature.

Further, in operation (d), the operation of the heating unit may be finished when the difference ΔT between the temperature T₂ of the drying furnace and the temperature T₃ of the outlet end of the heat exchanger has been maintained at a point not less than the first temperature for a time not shorter than a predetermined first time.

According to a second embodiment of the present invention, the method of controlling the finishing of the operation of the drying furnace assembly, further includes: (e) finishing the operation of the heating unit when the temperature T₂ of the drying furnace has been maintained at a point not less than a predetermined second temperature for a time not shorter than a predetermined second time.

In the first and second embodiments, only when the temperature T₂ of the drying furnace has been maintained at a point not less than a predetermined third temperature for a time not shorter than a predetermined third time, operation (d) may be proceeded after operation (c).

Further, the temperature T₃ of the outlet end of the heat exchanger may be a temperature detected in a recycling gas duct communicating the heat exchanger with the drying furnace.

According to a third embodiment of the present invention, operation (b) according to the first embodiment is operation at which the temperature T₁ of the inlet end of the heat exchanger is detected, and operation (d) is operation at which the operation of the heating unit is finished when a difference ΔT′ between the temperature T₁ of the inlet end of the heat exchanger and the temperature T₃ of the outlet end of the heat exchanger has been maintained at a point not less than a predetermined fourth temperature for a predetermined fourth time.

Here, the temperature T₁ of the inlet end of the heat exchanger may be a temperature detected in an exhaust gas duct communicating the heat exchanger with the drying furnace and the temperature T₃ of the outlet end of the heat exchanger may be a temperature detected in a recycling gas duct linking the heat exchanger with the drying furnace.

Further, the method according to the present invention may be adapted to a food waste disposer. In other words, the drying furnace may be a drying furnace of the food waste disposer, and the exhaust gas generated by a heating process performed in the drying furnace may be exhaust gas generated from a food waste disposal process performed in the drying furnace.

Here, the food waste disposer may further include: a suction and exhaust module communicating both with the exhaust gas duct and with the recycling gas duct, wherein the exhaust gas generated in the drying furnace may flow to the suction and exhaust module and may be discharged into the exhaust gas duct, and the recycling gas may be received from the recycling gas duct into the suction and exhaust module and, thereafter, may be received into the drying furnace, and the temperature T₃ of the outlet end of the heat exchanger may be a temperature detected in the recycling gas duct.

Here, the method may further include: (f) discharging treated food waste from the drying furnace after operation (d) when the temperature T₂ of the drying furnace is not higher than a fifth temperature and a fifth time has passed after the finishing of the operation of the heating unit.

### Advantageous Effects of Invention

As described above, the method of the present invention is advantageous in that it can in a timely and effective manner stop the operation of the heating unit at a proper time suitable for preventing the overheating of the drying furnace after the food waste disposal has been sufficiently finished in the waste disposer, without requiring separate confirmation of the state of food waste disposal in the drying furnace.

### BRIEF DESCRIPTION OF DRAWINGS

FIGS. 1a, 1b and 2 are perspective views of a food waste disposer in which a control method according to the present invention may be adapted and a block diagram schematically illustrating a flow of exhaust gas in the food waste disposer;

FIG. 3 is a flowchart of the method according to the present invention; and

FIG. 4 is a graph illustrating temperatures of a drying furnace, an exhaust gas duct and a recycling gas duct when the present invention is adapted thereto.

### DESCRIPTION OF REFERENCE CHARACTERS OF IMPORTANT PARTS

100: drying furnace 105: heating unit
200: suction and exhaust module
210: exhaust gas duct
215: exhaust gas duct temperature sensor
270: recycling gas duct
275: recycling gas duct temperature sensor
300: circulation fan 400: buffer tank
500: heat exchanger 550: cooling fan

### MODE FOR THE INVENTION

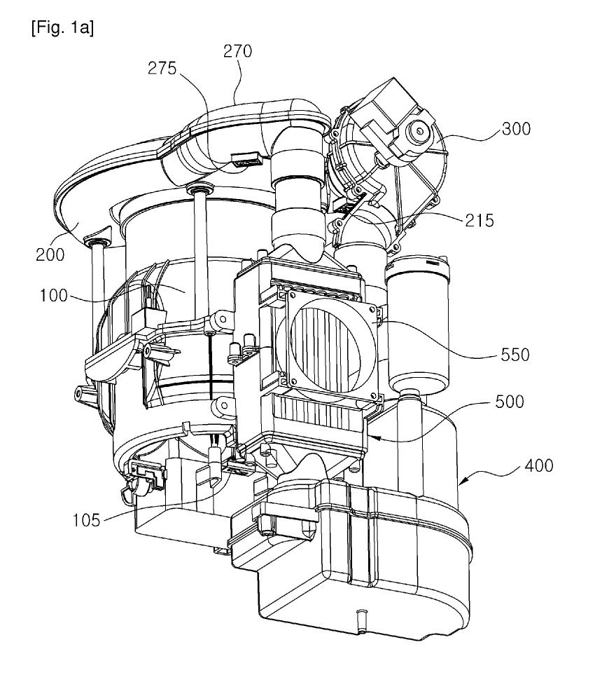

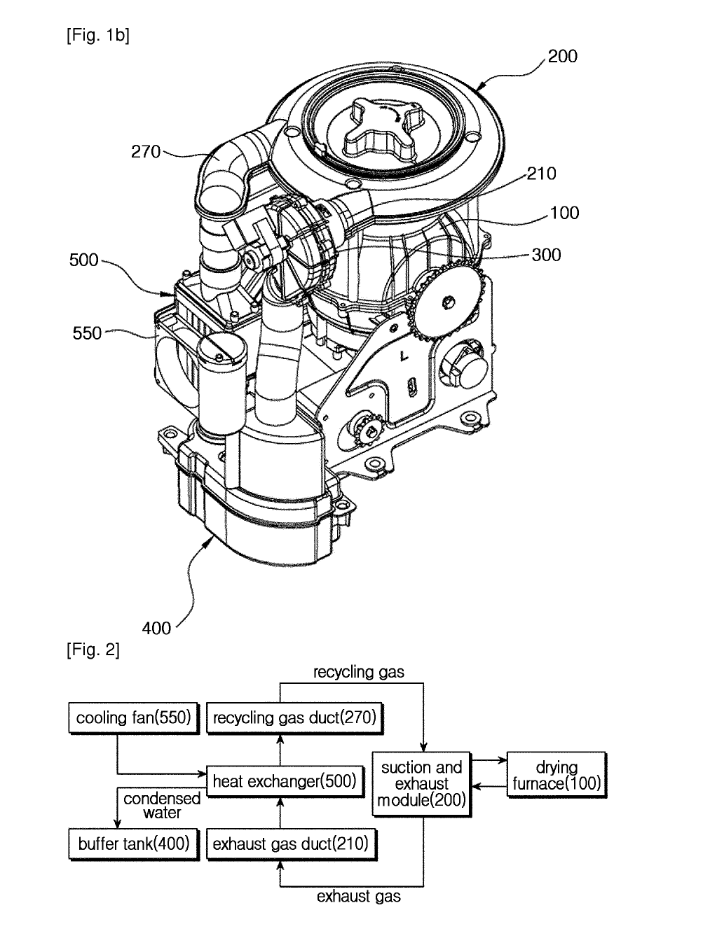

Hereinbelow, the construction of a recycling type food waste disposer will be described with reference to FIGS. 1a, 1b and 2. Although the illustrated food waste disposer is a recycling type food waste disposer, it is noted that the present invention may be freely adapted to an apparatus in which a heated drying furnace is provided and exhaust gas recycles. Further, it is noted that respective parts which will be described later herein may be configured as separate parts or as integral parts in which at least two parts are integrated with each other into a single part. Further, it is noted that respective operations which will be described later herein may be proceeded one by one or in a state in which at least two operations are proceeded at the same time.

The food waste disposer includes a drying furnace 100 in which food waste is received and treated, a suction and exhaust module 200 for discharging exhaust gas generated in the drying furnace 100 while treating the food waste and for receiving recycling gas, a circulation fan 300 for promoting the discharging of the exhaust gas, a heat exchanger 500 in which the exhaust gas exchanges heat, and a buffer tank 400 for temporarily storing condensed water generated by heat exchanging and for discharging the condensed water to the outside of the food waste disposer.

In the drying furnace 100, food waste to be treated may be received and crushing, agitating and/or drying processes for the food waste is proceeded, thus reducing the volume of the food waste and breaking the food waste into small pieces.

The drying furnace 100 is heated by a heating unit 105 and food waste received in the drying furnace is crushed and/or agitated by a crushing motor (not shown).

The drying furnace 100 generates high temperature exhaust gas while treating food waste. The exhaust gas is discharged into the heat exchanger 500 through the circulation fan 300, the suction and exhaust module 200 and an exhaust gas duct 210. In the heat exchanger 500, the exhaust gas is condensed to become recycling gas. Thereafter, the recycling gas recycles into the drying furnace 100 through a recycling gas duct 270 and the suction and exhaust module 200 (see FIG. 2).

In the drying furnace 100, a drying furnace temperature sensor (not shown) is installed and senses a temperature in the drying furnace 100. In the exhaust gas duct 210, an exhaust gas duct temperature sensor 215 is installed and senses a temperature of the exhaust gas duct 210. In the recycling gas duct 270, a recycling gas duct temperature sensor 275 is installed and senses a temperature of the recycling gas duct 270.

In the heat exchanger 500, the exhaust gas loses heat by a cooling fan 550 and becomes condensed water and the condensed water is temporarily stored in the buffer tank 400 and is, thereafter, discharged to the outside.

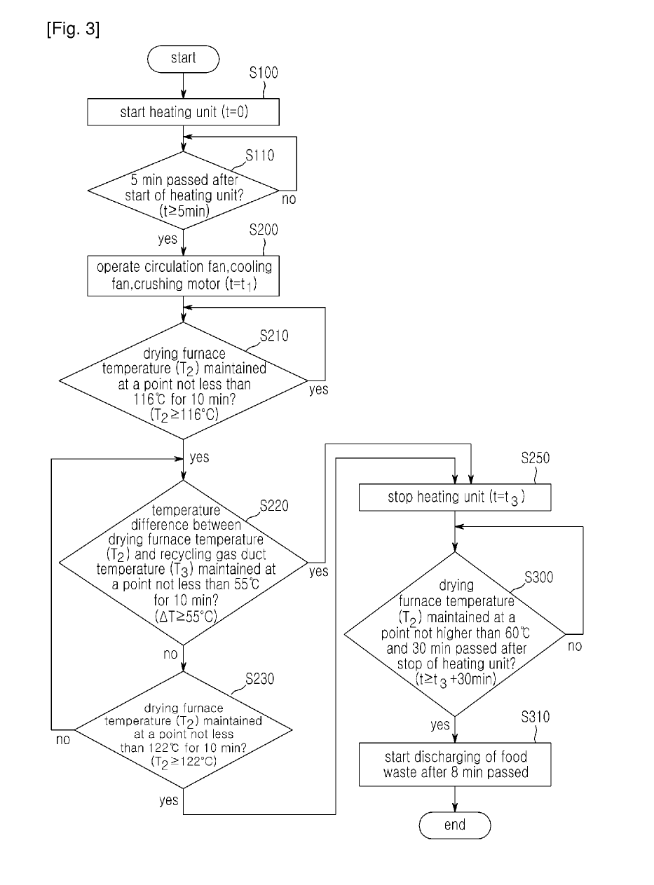

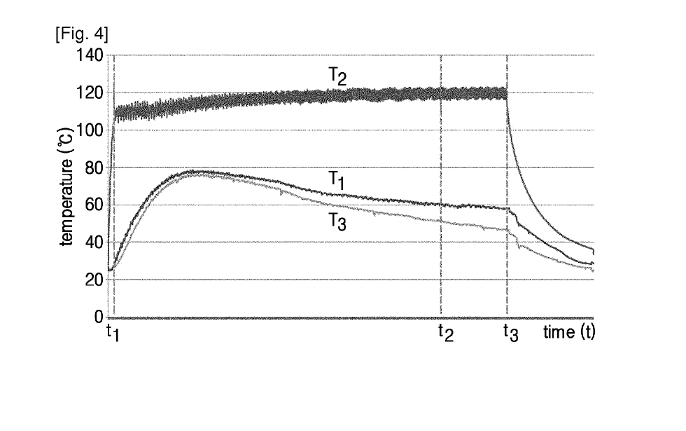

Hereinbelow, methods of controlling the finishing of the operation of the drying furnace assembly according to different embodiments of the present invention will be described with reference to FIGS. 3 and 4. In the embodiments, the drying furnace assembly includes: a drying furnace 100 having a heating unit 105; an exhaust gas duct 210; a recycling gas duct 270 and/or a heat exchanger 500.

Particularly, according to preferred embodiments of the present invention, a method of controlling the timing to finish the operation of the heating unit based on a difference ΔT between a drying furnace temperature T₂ and a temperature T₃ of the outlet end of the heat exchanger (first and second embodiments), or another method of controlling the timing to finish the operation of the heating unit based on a difference ΔT′ between a temperature T₁ of the inlet end of the heat exchanger and the temperature T₃ of the outlet end of the heat exchanger (third embodiment) may be provided.

The temperature T₁ of the inlet end of the heat exchanger 500, which is the temperature of exhaust gas that has not been subjected to the heat exchanging process, may be detected in the exhaust gas duct 210 located before the heat exchanger 500, as an example. Further, the temperature T₃ of the recycling gas that has been subjected to the heat exchanging process may be detected in the recycling gas duct 270 located after the heat exchanger 500, as an example.

Hereinbelow, for ease of description, the temperature T₁ of the inlet end of the heat exchanger will be referred to as “the exhaust gas duct temperature” and the temperature T₃ of the outlet end of the heat exchanger will be referred to as “the recycling gas duct temperature.”

### First Embodiment for Determining the Timing of Finishing the Operation of the Drying Furnace Assembly

In an embodiment of the present invention, the operation of the drying furnace assembly can be controlled based on the difference ΔT between the drying furnace temperature T₂ and the recycling gas duct temperature T₃.

When a user inputs an operation start signal, the heating unit 105 starts to preheat the drying furnace (S100, t=0) and maintains the preheating operation for about 5 minutes (S110).

After the preheating operation has been completed, the circulation fan 300, the cooling fan 550, and the crushing motor (not shown) are operated to treat food waste (S200, t=t₁). In other words, it is possible to detect whether the food waste disposer has been operated (t=t₁) or not by detecting the operation of at least one of the circulation fan 300, the cooling fan 550 and the crushing motor (not shown) in addition to the heating unit 105. In the above state, the heating unit 105 is being continuously operated.

The heating unit 105 is being continuously operated until the temperature T₂ of the drying furnace has been maintained at a point not less than a predetermined temperature for a predetermined time (S210). Due to the operation S210, it is possible to omit the operations (S220, etc) to unnecessarily determine the difference ΔT between the temperature T₂ of the drying furnace and the temperature T₃ of the recycling gas duct in a state in which the drying furnace 100 has not been sufficiently heated.

For ease of description, the above-mentioned predetermined temperature will be referred to as a “third temperature.” From a plurality of experiments, it is noted that the third temperature preferably ranges from 100° C. to 130° C. and is, most preferably, 116° C.

For ease of description, the above-mentioned predetermined time will be referred to as a “third time.” From a plurality of experiments, the third time preferably ranges from 5 minutes to 15 minutes and is, most preferably, 10 minutes.

Thereafter, the difference ΔT between the temperature T₂ of the drying furnace and the temperature T₃ of the recycling gas duct is determined in real time (S220).

When the difference ΔT between the temperature T₂ of the drying furnace and the temperature T₃ of the recycling gas duct has been maintained at a point not less than a predetermined temperature for a predetermined time, this means that the moisture contained in the food waste inside the drying furnace 100 has been sufficiently reduced, so that the operation of the heating unit 105 is stopped (S250).

For ease of description, the above-mentioned predetermined temperature will be referred to as a “first temperature.” From a plurality of experiments, it is noted that the first temperature preferably ranges from 50° C. to 60° C. and is, most preferably, 55° C.

For ease of description, the above-mentioned predetermined time will be referred to as a “first time.” From a plurality of experiments, it is noted that the first time preferably ranges from 5 minutes to 15 minutes and is, most preferably, 10 minutes.

### Second Embodiment for Determining the Timing of Finishing the Operation of the Drying Furnace Assembly

In another embodiment of the present invention, even when the difference ΔT between the temperature T₂ of the drying furnace and the temperature T₃ of the recycling gas duct has not been maintained at a point not less than the first temperature for a time not shorter the first time, it is possible to safely stop the operation of the heating unit 105 after executing an additional confirming process.

Even when the difference ΔT between the temperature T₂ of the drying furnace and the temperature T₃ of the recycling gas duct has not been maintained at a point not less than the first temperature for a time not shorter than the first time, the temperature T₂ of the drying furnace has been continuously detected. Here, when the detected temperature T₂ of the drying furnace has been maintained at a point not less than a predetermined temperature for a time not shorter than a predetermined time (S230, t=t₂+10 min), the operation of the heating unit 105 is stopped (S250).

For ease of description, the above-mentioned predetermined temperature will be referred to as a “second temperature.” From a plurality of experiments, it is noted that the second temperature preferably ranges from 115° C. to 130° C. and is, most preferably, 122° C.

For ease of description, the above-mentioned predetermined time will be referred to as a “second time.” From a plurality of experiments, it is noted that the second time preferably ranges from 5 minutes to 15 minutes and is, most preferably, 10 minutes.

### Third Embodiment for Determining the Timing of Finishing the Operation of the Drying Furnace Assembly

In a further embodiment of the present invention (not shown), the temperature T₁ of the exhaust gas duct may be used instead of the temperature T₂ of the drying furnace.

In other words, the temperature difference ΔT′ between the exhaust gas duct temperature T₁ and the recycling gas duct temperature T₃ has been continuously detected after the food waste disposal was started, and when the temperature difference ΔT′ has been maintained at a point not less than a predetermined temperature for a predetermined time, the operation of the heating unit 105 may be stopped.

For ease of description, the above-mentioned predetermined temperature will be referred as a “fourth temperature.” From a plurality of experiments, it is noted that the fourth temperature preferably ranges from 5° C. to 15° C. and is, most preferably, 10° C.

For ease of description, the above-mentioned predetermined time will be referred to as a “fourth time.” From a plurality of experiments, it is noted that the fourth time preferably ranges from 25 minutes to 35 minutes and is, most preferably, 30 minutes.

### Discharging Food Waste after Finishing the Operation of the Heating Unit

The process of discharging food waste is not directly proceeded after the operation of heating unit 105 was stopped (S250, t=t₃), but it is safe to proceed the process of discharging food waste after the temperature T₂ of the drying furnace has been reduced.

To accomplish this object, it is preferred that the process of discharging food waste be proceeded when the drying furnace temperature T₂ is not higher than a predetermined temperature and a predetermined time has passed after the finishing of the operation of the heating unit (S300).

Particularly, it is preferable that the process of discharging food waste be proceeded (S310) when about 8 minutes have passed after the operation S300.

For ease of description, the above-mentioned predetermined temperature will be referred to as a “fifth temperature.” From a plurality of experiments, it is noted that the fifth temperature preferably ranges from 55° C. to 65° C. an is, most preferably, 60° C.

For ease of description, the above-mentioned predetermined time will be referred to as a “fifth time.” From a plurality of experiments, it is noted that the fifth time preferably ranges from 25 minutes to 35 minutes and is, most preferably, 30 minutes.

Although the embodiments of the present invention have been disclosed for illustrative purposes, those skilled in the art will appreciate that various modifications, additions and substitutions are possible, without departing from the scope and spirit of the invention as disclosed in the accompanying claims.

1. A method of controlling a finishing of operation of a drying furnace assembly, the drying furnace assembly comprising: a drying furnace heated by a heating unit; and a heat exchanger receiving exhaust gas generated in the drying furnace through an inlet end of the heat exchanger and causing the inlet exhaust gas to exchange heat therein and to become recycling gas, and discharging the recycling gas through an outlet end thereof, wherein the recycling gas recycles into the drying furnace, the method comprising:
(a) operating the drying furnace;
(b) detecting a temperature (T₂) of the drying furnace;
(c) detecting a temperature (T₃) of the outlet end of the heat exchanger; and
(d) finishing the operation of the heating unit when a temperature difference (ΔT) between the temperature (T₂) of the drying furnace and the temperature (T₃) of the outlet end of the heat exchanger is not less than a predetermined first temperature.

2. The method of controlling the finishing of operation of the drying furnace assembly as set forth in claim 1, wherein
in operation (d), the operation of the heating unit is finished when the difference (ΔT) between the temperature (T₂) of the drying furnace and the temperature (T₃) of the outlet end of the heat exchanger has been maintained at a point not less than the first temperature for a time not shorter than a predetermined first time.

3. The method of controlling the finishing of operation of the drying furnace assembly as set forth in claim 2, further comprising:
(e) finishing the operation of the heating unit when the temperature (T₂) of the drying furnace has been maintained at a point not less than a predetermined second temperature for a time not shorter than a predetermined second time.

4. The method of controlling the finishing of operation of the drying furnace assembly as set forth in claim 3, wherein
the first temperature ranges from 50° C. to 60° C.,
the second temperature ranges from 115° C. to 130° C., and
each of the first time and the second time ranges from 5 minutes to 15 minutes.

5. The method of controlling the finishing of operation of the drying furnace assembly as set forth in claim 1, wherein
when the temperature (T₂) of the drying furnace has been maintained at a point not less than a predetermined third temperature for a time not shorter than a predetermined third time after operation (c) was finished, operation (d) is proceeded.

6. The method of controlling the finishing of operation of the drying furnace assembly as set forth in claim 5, wherein
the third temperature ranges from 100° C. to 130° C., and
the third time ranges from 5 minutes to 15 minutes.

7. The method of controlling the finishing of operation of the drying furnace assembly as set forth in claim 1, wherein
the temperature (T₃) of the outlet end of the heat exchanger is a temperature detected in a recycling gas duct communicating the heat exchanger with the drying furnace.

8. The method of controlling the finishing of operation of the drying furnace assembly as set forth in claim 1, wherein
operation (b) is operation at which a temperature (T₁) of the inlet end of the heat exchanger is detected, and
operation (d) is operation at which the operation of the heating unit is finished when a difference (ΔT′) between the temperature (T₁) of the inlet end of the heat exchanger and the temperature (T₃) of the outlet end of the heat exchanger has been maintained at a point not less than a predetermined fourth temperature for a predetermined fourth time.

9. The method of controlling the finishing of operation of the drying furnace assembly as set forth in claim 8, wherein
the fourth temperature ranges from 5° C. to 15° C., and
the fourth time ranges from 25 minutes to 35 minutes.

10. The method of controlling the finishing of operation of the drying furnace assembly as set forth in claim 8, wherein
the temperature (T₁) of the inlet end of the heat exchanger is a temperature detected in an exhaust gas duct communicating the heat exchanger with the drying furnace, and
the temperature (T₃) of the outlet end of the heat exchanger is a temperature detected in a recycling gas duct communicating the heat exchanger with the drying furnace.

11. The method of controlling the finishing of operation of the drying furnace assembly as set forth in claim 1, wherein
the drying furnace is a drying furnace of a food waste disposer, and the exhaust gas generated by a heating process performed in the drying furnace is exhaust gas generated from a food waste disposal process performed in the drying furnace.

12. The method of controlling the finishing of operation of the drying furnace assembly as set forth in claim 11, wherein
the food waste disposer further comprises: a suction and exhaust module communicating both with an exhaust gas duct and with a recycling gas duct, wherein
the exhaust gas generated in the drying furnace flows to the suction and exhaust module and is discharged into the exhaust gas duct, and the recycling gas is received from the recycling gas duct into the suction and exhaust module and is, thereafter, received into the drying furnace, and
the temperature (T₃) of the outlet end of the heat exchanger is a temperature detected in the recycling gas duct.

13. The method of controlling the finishing of operation of the drying furnace assembly as set forth in claim 12, further comprising:
(f) discharging treated food waste from the drying furnace after operation (d) when the temperature (T₂) of the drying furnace is not higher than a predetermined fifth temperature and a predetermined fifth time has passed after the finishing of the operation of the heating unit.

14. The method of controlling the finishing of operation of the drying furnace assembly as set forth in claim 13, wherein
the fifth temperature ranges from 55° C. to 65° C., and
the fifth time ranges from 25 minutes to 35 minutes.
